(19) United States
(12) Patent Application Publication
(10) Pub. No.: US 2025/0108320 A1
(43) Pub. Date: Apr. 3, 2025

(54) BUFFERING DEVICE FOR FILTER BOTTLE

(71) Applicants: Ching-Hsiung LIN, Pingtung City (TW); Kemflo (Nanjing) Environmental Technology Co., Ltd., Nanjing (CN); KEMFLO INTERNATIONAL CO., LTD., Pingtung City (TW)

(72) Inventors: Sheng-Nan LIN, Pingtung City (TW); Hao-Chan WEI, Pingtung City (TW); Zhe-Hua OU, Pingtung City (TW)

(21) Appl. No.: 18/540,048

(22) Filed: Dec. 14, 2023

(30) Foreign Application Priority Data
Sep. 28, 2023 (CN) 202311284895.1

(51) Int. Cl. B01D 35/14; B01D 35/30

(52) U.S. Cl. CPC B01D 35/14; B01D 35/30

(57) ABSTRACT

A buffering device for a filter bottle. The buffering device is disposed on a body of the filter bottle and has a sidewall, a top, a bottom, and a chamber. The top of the buffering device is moveable up and down along the sidewall of the buffering device. The chamber is formed between the sidewall, the top, and the bottom of the buffering device, and does not communicate with an interior of the filter bottle. The chamber communicates with an exterior via an air gap for air exchange. A filter bottle having the buffering device can provide a function of anti-water-hammer, can reduce a risk of leakage at a connection between the filter bottle and a valve head, and can provide an anti-freeze effect to reduce a risk of rupture of the filter bottle.

### BACKGROUND OF THE INVENTION

### 1. Field of the Invention

The present application relates to the technical field of water treatment, and in particular to a buffering device for a filter bottle.

### 2. Description of Related Art

Water hammer, or water shock, is a phenomenon caused by a sudden increase in pressure or pressure fluctuations in a fluid. This means that water flows in a long pipeline, and if a valve downstream of the pipeline is quickly closed at this time, the flow of water will have inertial momentum. Therefore, the inertial momentum of the water flow continues to push forward, causing the pressure in the pipeline to rise rapidly, causing damage to the pipeline. In the pipelines are used in households, it will slowly destroy the pipelines and generate noises, and the noises will cause a lot of nuisances and often make people mistakenly think that the noises are caused by their neighbors.

The size of the water hammer depends on a flow rate of a waterway and a head drop that refers to a drop between two ends of the pipeline. The greater the instantaneous flow rate and the head drop, the faster the flow speed will be, and the greater the inertial momentum of the water flow will be, resulting in the water hammer. The huge pressure may cause more shocking and may cause damage to the equipment. Therefore, a conventional pressure relief equipment is usually installed in the pipeline to release the pressure in the pipeline and to reduce a continuous shock wave oscillation to the water flow in the pipeline.

However, an operational ambient temperature of a conventional filter assembly changes greatly, especially filter assemblies installed outdoors. In low temperature environments, the water in the conventional filter assembly is prone to freezing. After freezing, the liquid volume of the water expands to increase the pressure inside a filter bottle of the conventional filter assembly, causing the conventional filter assembly to burst or be damaged and affecting the use.

The buffering device for a filter bottle and the filter bottle in accordance with the present invention mitigate or obviate the aforementioned problems.

### SUMMARY OF THE INVENTION

The main objective of the present invention is to provide a buffering device for a filter bottle that can provide a pre-filter with a function of anti-water-hammer and can reduce a risk of leakage at a connection between the filter bottle and a valve head, and can provide an anti-freeze effect to reduce a risk of rupture of the filter bottle.

The present invention has a buffering device for a filter bottle. The buffering device is disposed on a body of the filter bottle and has a sidewall, a top, a bottom, and a chamber. The top of the buffering device is moveable up and down along the sidewall of the buffering device. The chamber is formed between the sidewall, the top, and the bottom of the buffering device, and does not communicate with an interior of the filter bottle. The chamber communicates with an exterior via an air gap for air exchange. A filter bottle having the buffering device can provide a function of anti-water-hammer, can reduce a risk of leakage at a connection between the filter bottle and a valve head, and can provide an anti-freeze effect to reduce a risk of rupture of the filter bottle.

Other objects, advantages and novel features of the invention will become more apparent from the following detailed description when taken in conjunction with the accompanying drawings.

### BRIEF DESCRIPTION OF THE DRAWINGS

FIG. 1 is an enlarged and cross sectional perspective view of a buffering device for a filter bottle in accordance with the present invention;

FIG. 2 is an exploded and cross-sectional perspective view of the buffering device for a filter bottle in FIG. 1;

FIG. 3 is a cross sectional side view of the buffering device for a filter bottle in FIG. 1, in a normal state; and

FIG. 4 is an operational and cross-sectional side view of the buffering device for a filter bottle in FIG. 1, in an extruded state.

### DETAILED DESCRIPTION OF PREFERRED EMBODIMENT

The technical solutions in the embodiments of the present invention will be clearly and completely described below in conjunction with the drawings in the embodiments of the present application. Obviously, the described embodiments are only a part of the embodiments of the present invention, rather than all the embodiments. Based on the embodiments in the present invention, all other embodiments obtained by those skilled in the art without creative work belong to the scope of protection of the present invention.

The present embodiment provides a buffering device for a filter bottle. The buffering device is disposed on a body of a filter bottle and has a sidewall, a bottom, and a top. The top of the buffering device is moveable up and down along the sidewall of the buffering device. In order to ensure the sealing of the filter bottle, a chamber is formed between the sidewall, the bottom, and the top and does not communicate with an interior of the filter bottle. The chamber of the buffering device communicates with the exterior via an air gap for air exchange.

In a first embodiment.

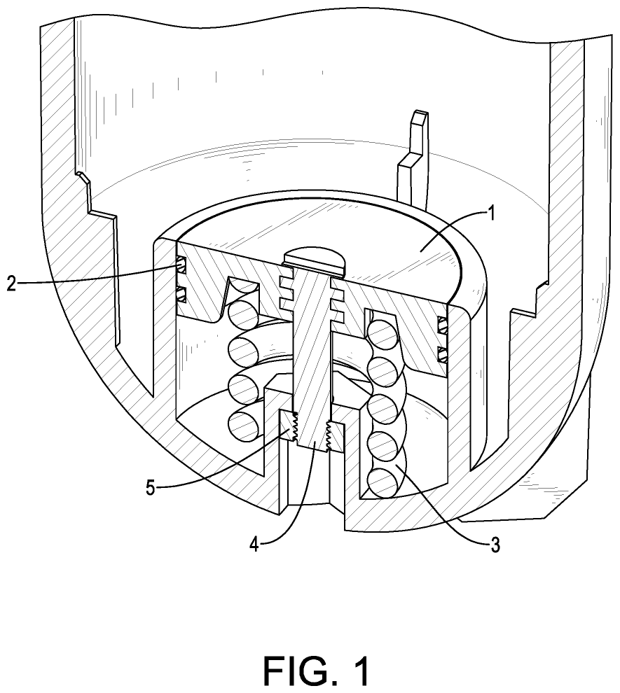

With reference to FIG. 1, the present invention provides a buffering device for a filter bottle, and the buffering device has an elastic element 3 disposed in a middle of the chamber. The elastic element 3 has two ends, and the two ends of the elastic element 3 respectively abut against the top and the bottom of the buffering device. When the pressure inside the filter bottle increases, the elastic element 3 can move the top downward along the sidewall to provide more space inside the filter bottle.

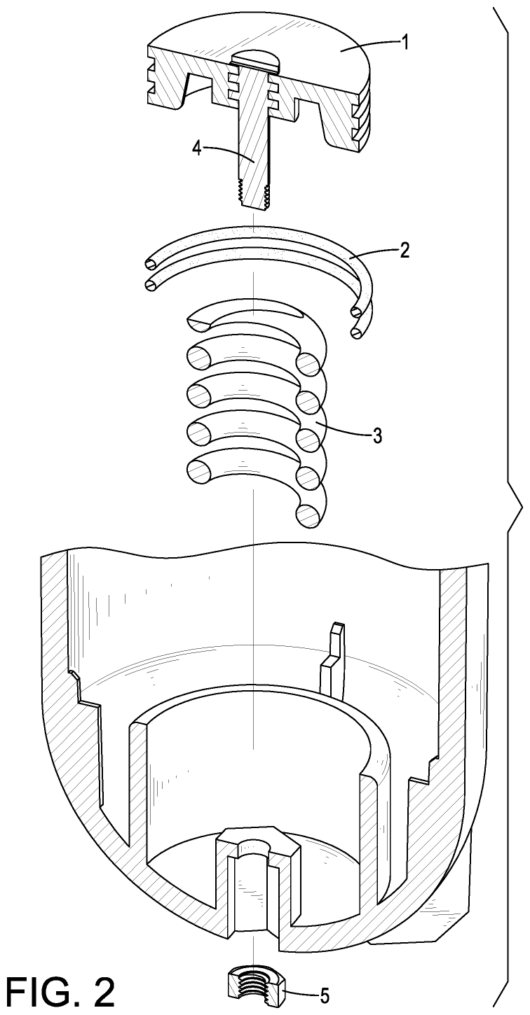

With reference to FIG. 2, in the first embodiment, in order to allow the top of the buffering device to move up and down in the sidewall, a middle column is disposed in the middle of the chamber. The middle column may be a fixing screw 4. The material of the top can be metal or plastic or a material with better rigidity. In the embodiment, the top is made of plastic, the middle column is made of stainless steel, and the stainless steel is embedded in the plastic by molding. The middle column is rigidly connected to the top. The middle column and the top can also be formed as a single piece with the same material. There is a reciprocating relative motion formed between the middle column and the bottom.

The middle column has a straight or crisscross-shaped slot formed on a top side of the middle column. When installing, a bottom end of the middle column is passed through a protruded mount and is securely connected to a fixing nut 5 by a screwdriver.

Furthermore, the buffering device has a through hole disposed on the bottom, the middle column is inserted through the through hole, and the air gap is formed between the middle column and the through hole. When the pressure inside the filter bottle increases, the top compresses the air in the chamber toward the bottom, and the compressed air flows out of the filter bottle via the air gap. After the pressure inside the filter bottle recovers, the top is moved upwardly to the original location by a compressed elastic force of the elastic element 3, the air outside the filter bottle flows into the chamber via the air gap to realize the exchange of air inside the chamber with the outside.

In order to enable the top to move smoothly, the buffering device has a protruding mount disposed on the bottom for positioning the elastic element 3, and the through hole is disposed on the protruding mount. On one hand, on a side of the protruding mount facing the exterior of the filter bottle, the middle column contacts an inner side of the protruding mount by the fixing nut 5, and this provides a positioning and guiding effect to the middle column. In assembly, the bottom end of the middle column passes through the protruding mount and is connected to the fixing nut 5. The middle column is moved back and forth in a channel that is formed and restricted by the protruding mount. On the other hand, on a side of the protruding mount facing the inside of the filter bottle, the elastic element 3 is mounted around the protruding mount to facilitate the installation of the elastic element 3.

In the present invention, the elastic element 3 is a deformation and recovery device that can facilitate the top to perform up and down reciprocating movement. As a preferred solution in the present invention, a spring is selected as the elastic element 3.

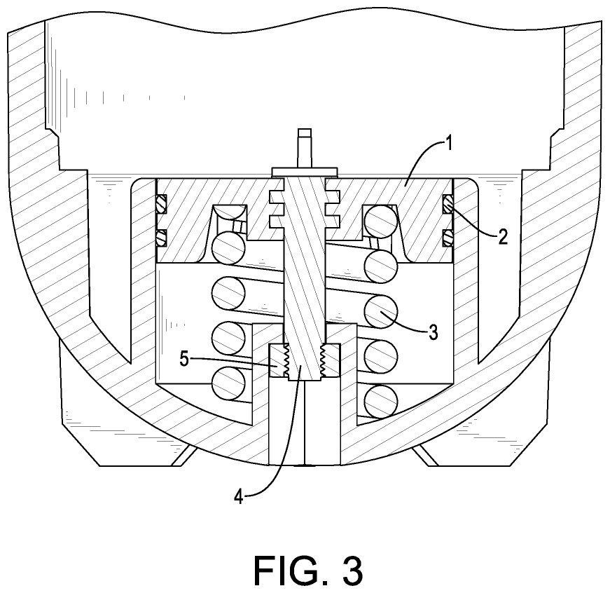

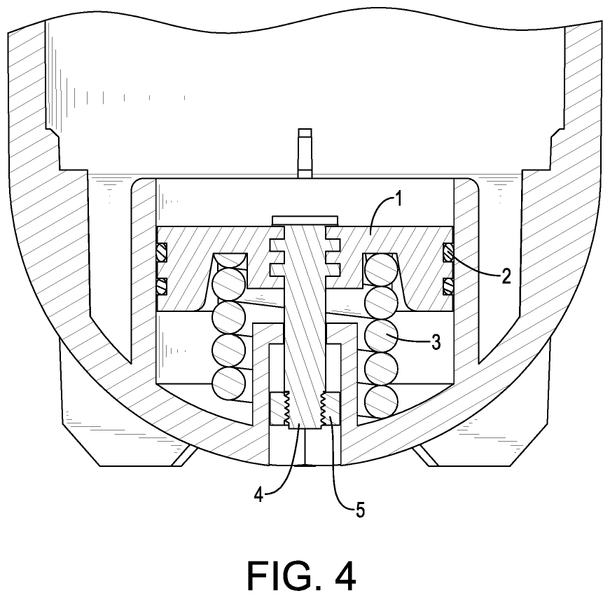

With reference to FIGS. 3 and 4, in the present invention, the top may be a piston 1, and the piston 1 is disposed above the chamber and has an outer flange closely contacted with the sidewall. In order to enhance the sealing performance between the piston 1 and the sidewall, a sealing assembly 2 is disposed at a contacting position between the piston 1 and the sidewall to ensure that the liquid in the filter bottle will not enter the chamber and improve the airtightness of the chamber.

In a second embodiment.

The present invention further provides a filter bottle. The filter bottle has the buffering device as defined in the first embodiment, and a volume of the chamber is calculated based on a volume of the filter bottle. The buffering device is in contact with the liquid inside the filter bottle.

In the second embodiment, the filter bottle can be of various types such as a pre-filter device, a composite filter device, etc., especially the filter device installed outdoors which has a large range of ambient temperature changes. After the temperature drops to freezing, the space in the chamber is completely occupied by frozen water, and the piston 1 is moved to a maximum limit position, and the volume is increased to the limit, which reduces the pressure in the filter bottle and protects the filter bottle to a greatest extent.

Considering the structure stability and operability of the filter bottle, the buffering device is disposed at a bottom of the filter bottle.

In a third embodiment.

Based on the second embodiment, in order to maximize and utilize the space inside the filter bottle, the volume of the chamber in the buffering device is designed according to a purification capacity of the filter bottle. In the present invention, the volume of the chamber is set to be greater than 11% of the purification capacity of the filter bottle, that is said to be greater than 11% of the volume that water expands when it freezes, and this can absorb the volume that expands after freezing to achieve a preferred explosion-proof effect and maximum space utilization.

The buffering device for a filter bottle and the filter bottle in accordance with the present invention have the following advantages.
1. The buffering device for a filter bottle of the present invention forms a chamber in the filter bottle by the piston 1 and the elastic element 3 to adjust the pressure in the filter bottle and absorb the huge pressure generated from the water hammer of the water in the pipeline.
2. In cold areas, when there is frozen water inside the filter bottle, the pressure inside the filter bottle will be increased, the piston 1 will be pushed by the increased pressure to compress the elastic element 3, and a receiving space is created by the movement of the piston 1 for absorbing the expansion volume of the frozen water and to prevent the huge pressure generated by the expansion of the frozen water from breaking and damaging the filter bottle.
3. In the present invention, the volume of air inside the filter bottle can be adjusted by the movement of the piston 1, and the structure of the buffering device is simple and is easy to implement, and this enables the present invention to have strong application prospects.

The above are only the preferred embodiments of the present invention. It should be pointed out that for those of ordinary skill in the art, without departing from the principles of this application, several improvements and modifications can be made, and these improvements and modifications should also be considered the scope of protection of the present invention.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A buffering device for a filter bottle, the buffering device disposed on a body of the filter bottle and comprising:
a sidewall;
a top being moveable up and down along the sidewall of the buffering device;
a bottom; and
a chamber formed between the sidewall, the bottom, and the top of the buffering device without communicating with an interior of the filter bottle, and communicating with an exterior via an air gap for air exchange.

2. The buffering device for a filter bottle claimed in claim 1, wherein
the buffering device has an elastic element disposed in a middle of the chamber; and
the elastic element has two ends respectively abutted against the top and the bottom of the buffering device.

3. The buffering device for a filter bottle claimed in claim 1, wherein
the buffering device has a middle column in a middle of the chamber;
the middle column is rigidly connected to the top of the buffering device; and
a reciprocating relative motion is formed between the middle column and the bottom of the buffering device.

4. The buffering device for a filter bottle claimed in claim 3, wherein
the buffering device has a through hole disposed on the bottom of the buffering device;
the middle column is inserted through the through hole; and
the air gap is formed between the middle column and the through hole.

5. The buffering device for a filter bottle claimed in claim 4, wherein
the buffering device has
an elastic element disposed in the middle of the chamber; and
a protruding mount disposed on the bottom for positioning the elastic element; and
the through hole is disposed on the protruding mount.

6. The buffering device for a filter bottle claimed in claim 2, wherein the elastic element is a spring.

7. The buffering device for a filter bottle claimed in claim 5, wherein the elastic element is a spring.

8. The buffering device for a filter bottle claimed in claim 1, wherein
the top of the buffering device is a piston; and
the piston is disposed above the chamber and has an outer flange closely contacted with the sidewall of the buffering device.

9. The buffering device for a filter bottle claimed in claim 8, wherein the buffering device has a sealing assembly disposed at a contacting position between the piston and the sidewall of the buffering device.

10. A filter bottle comprising the buffering device as claimed in claim 1, wherein
a volume of the chamber in the buffering device is calculated based on a volume of the filter bottle; and
the buffering device is configured to be in contact with a liquid inside the filter bottle.

11. A filter bottle comprising the buffering device as claimed in claim 2, wherein
a volume of the chamber in the buffering device is calculated based on a volume of the filter bottle; and
the buffering device is configured to be in contact with a liquid inside the filter bottle.

12. A filter bottle comprising the buffering device as claimed in claim 3, wherein
a volume of the chamber in the buffering device is calculated based on a volume of the filter bottle; and
the buffering device is configured to be in contact with a liquid inside the filter bottle.

13. A filter bottle comprising the buffering device as claimed in claim 4, wherein
a volume of the chamber in the buffering device is calculated based on a volume of the filter bottle; and
the buffering device is configured to be in contact with a liquid inside the filter bottle.

14. A filter bottle comprising the buffering device as claimed in claim 5, wherein
a volume of the chamber in the buffering device is calculated based on a volume of the filter bottle; and
the buffering device is configured to be in contact with a liquid inside the filter bottle.

15. A filter bottle comprising the buffering device as claimed in claim 6, wherein
a volume of the chamber in the buffering device is calculated based on a volume of the filter bottle; and
the buffering device is configured to be in contact with a liquid inside the filter bottle.

16. A filter bottle comprising the buffering device as claimed in claim 7, wherein
a volume of the chamber in the buffering device is calculated based on a volume of the filter bottle; and
the buffering device is configured to be in contact with a liquid inside the filter bottle.

17. A filter bottle comprising the buffering device as claimed in claim 8, wherein
a volume of the chamber in the buffering device is calculated based on a volume of the filter bottle; and
the buffering device is configured to be in contact with a liquid inside the filter bottle.

18. A filter bottle comprising the buffering device as claimed in claim 9, wherein
a volume of the chamber in the buffering device is calculated based on a volume of the filter bottle; and
the buffering device is configured to be in contact with a liquid inside the filter bottle.

19. The filter bottle as claimed in claim 10, wherein the buffering device is disposed on a bottom of the filter bottle.

20. The filter bottle as claimed in claim 11, wherein the buffering device is disposed on a bottom of the filter bottle.

21. The filter bottle as claimed in claim 12, wherein the buffering device is disposed on a bottom of the filter bottle.

22. The filter bottle as claimed in claim 13, wherein the buffering device is disposed on a bottom of the filter bottle.

23. The filter bottle as claimed in claim 14, wherein the buffering device is disposed on a bottom of the filter bottle.

24. The filter bottle as claimed in claim 15, wherein the buffering device is disposed on a bottom of the filter bottle.

25. The filter bottle as claimed in claim 16, wherein the buffering device is disposed on a bottom of the filter bottle.

26. The filter bottle as claimed in claim 17, wherein the buffering device is disposed on a bottom of the filter bottle.

27. The filter bottle as claimed in claim 18, wherein the buffering device is disposed on a bottom of the filter bottle.
